(19) United States
(12) Patent Application Publication
(10) Pub. No.: US 2009/0197654 A1
(43) Pub. Date: Aug. 6, 2009

(54) MOBILE APPARATUS AND MOBILE PHONE

(75) Inventors: Masao TESHIMA, Tokyo (JP); Koichi SATO, Tokyo (JP); Hiromichi SUZUKI, Tokyo (JP); Miki MORI, Yokohama-shi (JP); Tetsuya YAMAMOTO, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/269,446

(22) Filed: Nov. 12, 2008

(30) Foreign Application Priority Data
Jan. 31, 2008 (JP) P2008-021984

(51) Int. Cl. H04M 1/00

(52) U.S. Cl. 455/575.7

(57) ABSTRACT

According to one aspect of the invention, there is provided a mobile apparatus including: a resin body having a circumferential portion; a loop antenna disposed along the circumferential portion; and a printed circuit board configured to mount electronic components thereon, wherein the resin body is formed continuously and the loop antenna and the printed circuit board are embedded in the resin body.

The entire disclosure of Japanese Patent Application No. 2008-021984 filed on Jan. 31, 2008, including specification, claims, drawings and abstract is incorporated herein by reference in its entirety.

### BACKGROUND

1. Field of the Invention

One aspect of the present invention relates to a thin-sized mobile apparatus, and more particularly, to a mobile apparatus having a Radio Frequency Identification (RFID) antenna with high rigidity in addition to an antenna function.

2. Description of the Related Art

As a type of a mobile phone, there is a thin-sized mobile phone. In this case, it is necessary to improve rigidity of the mobile phone. In addition, it is conceivable to mount an antenna for non-contact data communication such as RFID on such a thin-sized mobile phone.

There is a mobile phone (data communication device) having the antenna for non-contact data communication therein (see JP-A-2005-26865 (page 4, FIG. 1, FIG. 3, and FIG. 4)). A mobile apparatus 1 has a known foldable structure including a main body 2 and a display 3, and a loop coil antenna 5 for non-contact data communication is disposed to be wound over a whole circumference of an inside of a case 2a of a main body 2. The loop coil antenna 5 is formed, of a conducting wire as a thin copper pattern on a flexible printed circuit board 10. In JP-A-2005-26865, there is a description that the loop coil antenna 5 may be directly buried in a side of the case 2a of resin.

In the mobile phone 1 described in JP-A-2005-26865, the loop coil antenna 5 is directly buried in the side of the outer peripheral case 2a of resin, or is mounted thereon by adhering and fixing. Although not shown, other components are mounted on an inner structures. Then, the structures are covered with the case 2a to surround the structures, thereby forming the mobile apparatus 1. The known general mobile apparatus has the structure of covering the inner structures with the outer peripheral case. In such a structure, to improve rigidity of the mobile apparatus, it is necessary to improve rigidity of the outer peripheral case 2a or rigidity of the inner structures. In a method for manufacturing the mobile apparatus, after assembling the inner structures, it is further necessary to perform a process of covering the inner structures with the outer peripheral case, and thus a large number of processes are necessary.

### SUMMARY

According to one aspect of the invention, there is provided a mobile apparatus including; a resin body having a circumferential portion; a loop antenna disposed along the circumferential portion; and a printed circuit board configured to mount electronic components thereon, wherein the resin body is formed continuously and the loop antenna and the printed circuit board are embedded in the resin body.

### BRIEF DESCRIPTION OF THE DRAWINGS

Embodiment may be described in detail with reference to the accompanying drawings, in which:

FIG. 1 is an exemplary view illustrating appearance of a mobile apparatus according to an exemplary first Embodiment and a second Embodiment of the invention;

FIG. 2 is an exemplary perspective view illustrating appearance of a mobile apparatus according to the first Embodiment, and appearance of a loop antenna built therein;

FIGS. 3A to 3C are exemplary views illustrating arrangement of components of the mobile apparatus according to the first Embodiment;

FIGS. 4A to 4C are exemplary transparent views illustrating processes for manufacturing the mobile apparatus according to the first Embodiment; and

FIG. 5 is an exemplary view illustrating appearance of the mobile apparatus according to the second Embodiment, and appearance of a loop antenna built therein.

### DETAILED DESCRIPTION OF THE EMBODIMENTS

Hereinafter, embodiments of the invention will be described with reference to the drawings.

### First Embodiment

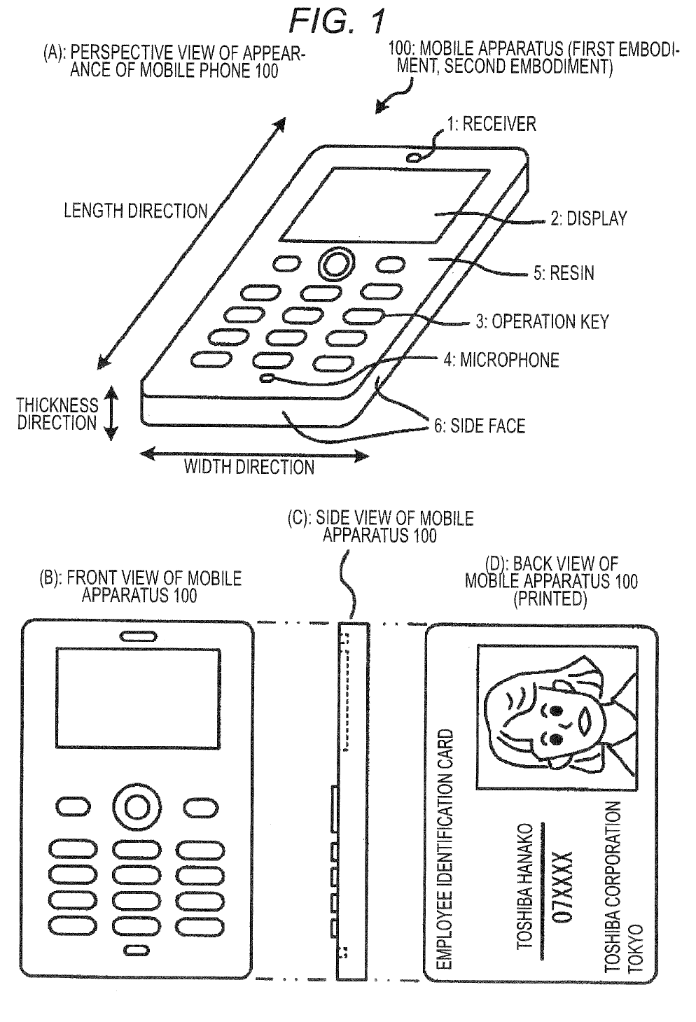

FIG. 1 is a view illustrating appearance of a mobile apparatus according to the first Embodiment and the second Embodiment of the invention, in which Section (A) is a perspective view, Section (B) is a front view, Section (C) is a side view, and Section (D) is a back view. A mobile apparatus 100 has a thin-sized shape, and is shown in three-dimensional direction of a length direction, a width direction, and a thickness direction.

The mobile apparatus 100 is provided with a receiver 1, a display 2, a plurality of operation keys 3, and a microphone 4 on the front. The whole mobile apparatus 100 is molded with resin 5, so that the components are surrounded and the surfaces thereof are visible, thereby forming the whole shape of the mobile apparatus 100. A loop antenna is mounted in an outer peripheral portion of a side face 6 of the mobile apparatus 100. An ID card such as an employee identification card is printed on a back face of the mobile apparatus 100.

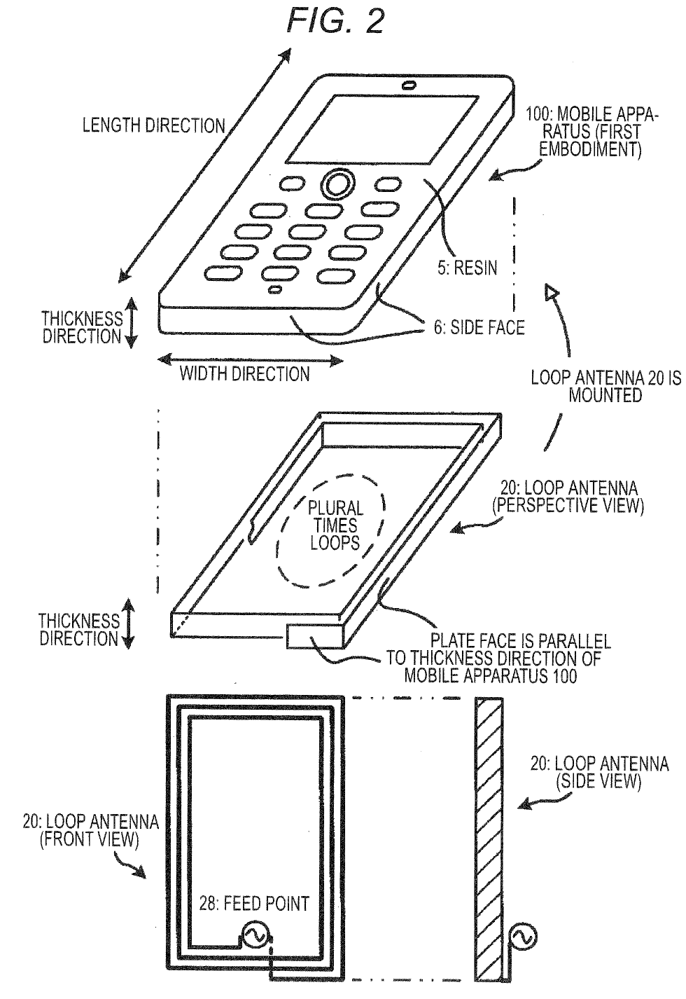

FIG. 2 is a perspective view illustrating appearance of the mobile apparatus 100 according to the first Embodiment, and appearance of the loop antenna. The mobile apparatus 100 is molded with the resin 5 to mount the loop antenna 20 therein.

The loop antenna 20 is disposed in the outer peripheral portion of the side face 6 of the mobile apparatus 100. The loop antenna 20 is formed of a metal plate, and the metal plate is disposed parallel to the thickness direction of the mobile apparatus 100. When the number of loop times is plural, each face of a loop piles up from the side face 6 toward the center.

Accordingly, rigidity against bending in the length direction and width direction of the mobile apparatus 100 is strengthened. Since the loop antenna 20 is disposed in the outer peripheral portion, the loop) antenna 20 is hardly affected by an inner conductor of the mobile apparatus 100 and thus an antenna characteristic is improved. The loop antenna 20 is not limited to the metal plate, and may be formed of a material having high rigidity.

The start point and end point of the loop antenna 20 are connected to a radio circuit formed on a printed circuit board (not shown) as a feed point 28.

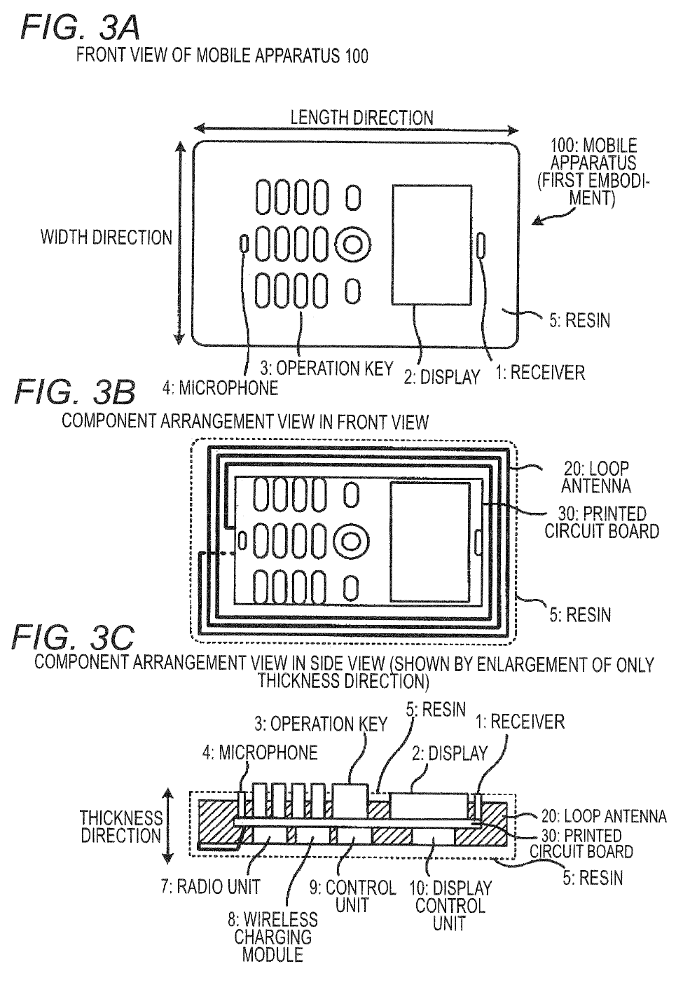

FIGS. 3A to 3C are views illustrating component arrangement of the mobile apparatus according to the first Embodiment. FIG. 3A is a front view of appearance of the mobile apparatus 100. FIG. 3B shows components shown from the outside of the mobile apparatus 100, and built-in components in a transparent state. FIG. 3C is a component arrangement viewed from the side and shows the components visible from the outside of the mobile apparatus 100, and the built-in components in the transparent state.

As the built-in components, there are the loop antenna 20 and the printed circuit board 30. On the printed circuit board 30, the receiver 1, the display 2, the plurality of operation keys 3, and the microphone 4 which are visible from the outside of the mobile apparatus 100, and a radio unit 7, a wireless charging module 8, a control unit 9, and a display control unit 10, which are invisible from the outside, are mounted therein by soldering.

The resin 5 is filled and hardened so that the front surfaces of the receiver 1, the display 2, the operation keys 3, and the microphone 4 as user input/output means for user interface are visible from the outside. The receiver 1 and the microphone 4 do not need to be directly visible from the outside, and may have a structure allowing transmitting sound. The other components are embedded in the resin 5 not to be visible from the outside.

The wireless charging module 8 is a power supply unit that is charged with non-contact electron induction by a charger (not shown) provided outside the mobile apparatus 100, and supplies electric power to the whole mobile apparatus 100.

The loop antenna 20 built in the mobile apparatus 100 is reinforced with the resin 5 and is included therein, thereby strengthening rigidity against bending in the length direction and width direction of the mobile apparatus 100.

[Manufacturing Method]

A method for manufacturing the mobile apparatus 100 with such a configuration will be described hereinafter. In the manufacturing method of the Embodiment, a plurality of mobile apparatuses are manufactured in a state that the plurality of mobile apparatuses are connected, and finally, the mobile apparatus are taken out from a mold, thereby manufacturing each mobile apparatus 100.

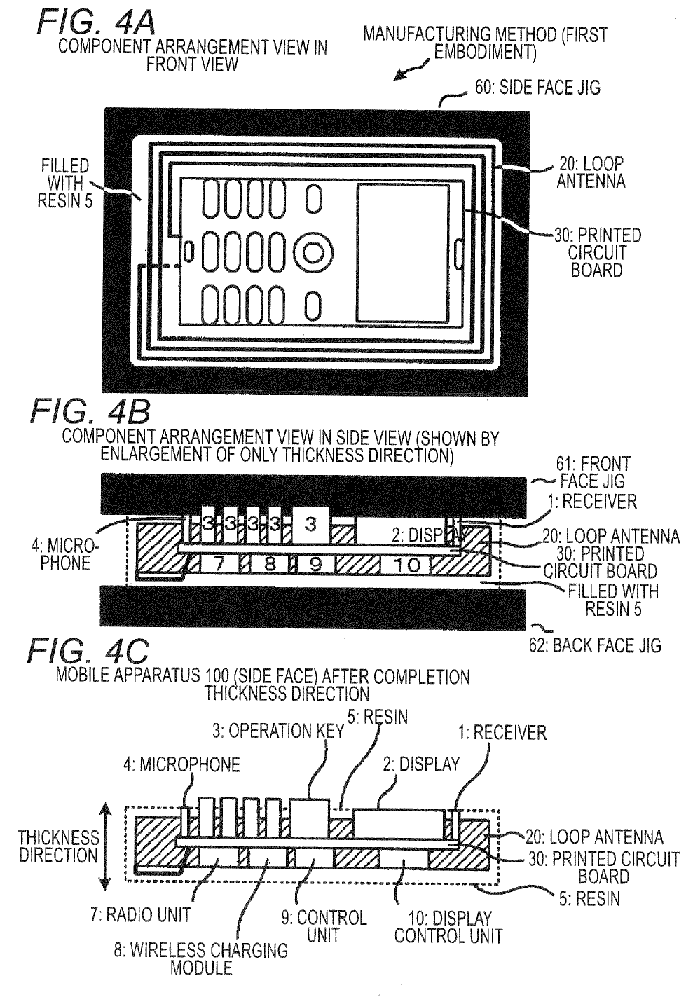

FIGS. 4A to 4B are transparent views illustrating the method for manufacturing the mobile apparatus according to the first Embodiment. FIG. 4A is a component arrangement viewed from the front. FIG. 4B is a component arrangement viewed from the side. FIG. 4C is a side view illustrating the manufactured mobile apparatus 100.

First, predetermined components are soldered on the printed circuit board 30 to form a substrate unit. Then, the loop antenna 20 and the printed circuit board 30 are disposed in a space formed by a side face jig 60, a front face jig 61, and a back face jig 62, as shown in FIG. 4A and FIG. 4B.

The front: face jig 61 has a shape to contact with the front surfaces of the receiver 1, the display 2, the operation keys 3, and the microphone 4 used as user input/output means for user interface, among the components mounted on the mobile apparatus 100, so that the surfaces are not filled up with the resin 5.

The side face jig 60, the front face jig 61, and the back face jig 62 are positioned so that the other mounted components of the radio unit 7, the wireless charging module 8, the control unit 9, the display control unit 10, the loop antenna 20, and the printed circuit board 30 are encapsulated by the resin 5. A space formed by the side face jig 60, the front face jig 61, and the back face jig 62 is continuously filled up with the resin 5, and the resin 5 is hardened, thereby manufacturing the mobile apparatus 100 as shown in FIG. 4C.

According to the first Embodiment, the loop antenna and the printed circuit board with high rigidity are built in the mobile apparatus by filling with the resin. Therefore, it is possible to provide a mobile apparatus having a thin-sized shape with high rigidity while the case can be essentially removed.

The wireless charging module 8 is mounted as a power supply unit, but the other power supply unit such as a battery may be mounted. Heating components provided in the mobile apparatus 100 may be connected to the loop antenna 20 through a thermal conductive sheet or the like, and thus the loop antenna disposed in the outer peripheral portion may be used for heat radiation.

The mobile apparatus 100 may be applied to a thin-sized mobile phone, a PHS, a PDA, and the like. In addition, the mobile apparatus 100 may be applied to various cards having no operation key or display.

### Second Embodiment

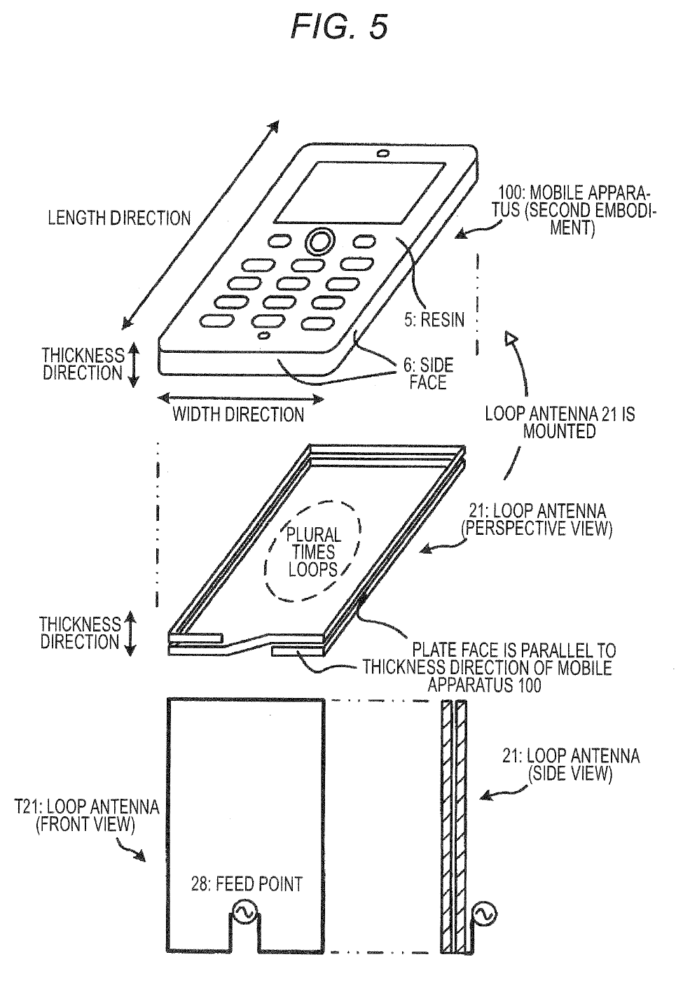

FIG. 5 is a perspective view illustrating appearance of a mobile apparatus according to a second Embodiment of the invention, and appearance of a loop antenna built therein. The appearance of the mobile apparatus is the same as shown in FIG. 1, and the description thereof is omitted. A loop antenna 21 according to the second Embodiment has a shape different from that of the loop antenna 20 according to the first Embodiment shown in FIG. 2, and the different part will be mainly described.

The loop antenna 21 is disposed in the outer peripheral-portion of the side face 6 of the mobile apparatus 100. The loop antenna 21 is formed of a metal plate, and a plate face thereof is disposed parallel to the thickness direction of the mobile apparatus 100. When the number of loop times is plural, each face of a loop piles up on the same face parallel to the thickness direction of the mobile apparatus 100.

With such a configuration, it is possible to reduce a volume occupied by the loop antenna in a direction from the side face 6 toward the center as compared with the case of the loop antenna 20 according to the first Embodiment.

In this Embodiment, basic component arrangement and a manufacturing method are the same as the first Embodiment shown in FIGS. 3A to 3C (arrangement of components) and FIGS. 4A to 4C (manufacturing method), but there is a difference that the shape of the loop antenna 20 is changed to the shape of the loop antenna 21.

According to the second Embodiment, in addition to the advantage of the first Embodiment, the volume occupied by the loop antenna in the direction from the side face toward the center of the mobile apparatus can be reduced.

What is claimed is:

1. A mobile apparatus comprising:
a resin body having a circumferential portion;
a loop antenna disposed along the circumferential portion; and
a printed circuit board configured to mount electronic components thereon,
wherein the resin body is formed continuously and the loop antenna and the printed circuit board are embedded in the resin body.

2. The mobile apparatus of claim 1, wherein the loop antenna includes a conductive plate that is disposed parallel to a thickness direction of the resin body.

3. The mobile apparatus of claim 2, wherein the conductive plate includes a plurality of looped plates that are superimposed in a direction from the circumferential portion to a center of the resin body.

4. The mobile apparatus of claim 2, wherein the conductive plate includes a plurality of looped plates that are superimposed within a same face parallel to the thickness direction.

5. The mobile apparatus of claim 1, wherein:
the electronic components include at least an operation key and a display unit, the operation key having an operation face, the display unit having a display face; and
the operation key and the display unit are provided so that the operation face and the display face are exposed outside the resin body.

6. The mobile apparatus of claim 1, wherein the resin body includes a back face, the back face having visible user information printed thereon.

7. A mobile apparatus comprising:
a body having a flat-boxed shape;
a loop antenna; and
a printed circuit board configured to mount electronic components thereon,
wherein the body is formed of resin and the loop antenna and the printed circuit board are embedded in the body.

8. The mobile apparatus of claim 7, wherein the body has a circumferential portion and the loop antenna is disposed along the circumferential portion.

9. The mobile apparatus of claim 8, wherein the loop antenna includes a conductive plate that is disposed parallel to a thickness direction of the body.

10. The mobile apparatus of claim 9, wherein the conductive plate includes a plurality of looped plates that are superimposed in a direction from the circumferential portion to a center of the body.

11. The mobile apparatus of claim 9, wherein the conductive plate includes a plurality of looped plates that are superimposed within a same face parallel to the thickness direction.

12. The mobile apparatus of claim 7, wherein:
the electronic components include at least an operation key and a display unit, the operation key having an operation face, the display unit having a display face; and
the operation key and the display unit are provided so that the operation face and the display face are exposed outside the body.

13. The mobile apparatus of claim 7, wherein the body includes a back face, the back face having visible user information printed thereon.

14. A mobile phone comprising:
a body having a flat-boxed shape;
a loop antenna; and
a printed circuit board configured to mount electronic components thereon,
wherein the body is formed of resin and the loop antenna and the printed circuit board are embedded in the body.

15. The mobile phone of claim 14, wherein the body has a circumferential portion and the loop antenna is disposed along the circumferential portion.

16. The mobile phone of claim 15, wherein the loop antenna includes a conductive plate that is disposed parallel to a thickness direction of the body.

17. The mobile phone of claim 16, wherein the conductive plate includes a plurality of looped plates that are superimposed in a direction from the circumferential portion to a center of the body.

18. The mobile phone of claim 16, wherein the conductive plate includes a plurality of looped plates that are superimposed within a same face parallel to the thickness direction.

19. The mobile phone of claim 14, wherein:
the electronic components include at least an operation key and a display unit, the operation key having an operation face, the display unit having a display face; and
the operation key and the display unit are provided so that the operation face and the display face are exposed outside the body.

20. The mobile phone of claim 14, wherein the body includes a back face, the back lace having visible user information printed thereon.
